(19) United States
(12) Patent Application Publication
(10) Pub. No.: US 2006/0273724 A1
(43) Pub. Date: Dec. 7, 2006

(54) CCFL device with a principal amalgam

(76) Inventor: Henry Yuk Ho Kwong, Hong Kong (HK)

Correspondence Address: KWONG, YUK HO HENRY, 11/F, MINERVA HOUSE, 34 LYTTELTON ROAD, MID-LEVELS, HONG KONG, HONG KONG, HK

(21) Appl. No.: 11/467,655

(22) Filed: Aug. 28, 2006

(51) Int. Cl. H01J 61/30

(52) U.S. Cl. 313/634

(57) ABSTRACT

An improved CCFL gas discharge device that uses a principal amalgam alone to control the mercury vapor pressure inside its glass envelope so that it can generate optimum light output while being enclosed inside a light-transmitting container with high ambient temperature. Another embodiment of the present invention uses a fast start circuitry in the electronic driver that allows the CCFL to reach optimum intensity within two minutes of start in case when a high-melting point principal amalgam is used. Still another embodiment of the present invention uses a complimentary pair of PNP and NPN transistor to reduce the complexity of the electronic driver so that it uses fewer components and is more compact.

### BACKGROUND OF THE INVENTION

The present invention pertains generally to the low pressure mercury vapor gas discharge fluorescent devices, and more particularly to an improved cold cathode fluorescent lamp (CCFL) device comprising at least one elongated CCFL that is bent into a pre-determined shape such as a spiral, double-spiral, cone, serpentine, 1-U, 2-Us, multi-Us, and etc. Said CCFL uses a principal amalgam to control the mercury vapor pressure inside its glass envelope so that it can generate optimum light output while being enclosed inside a light-transmitting container with high ambient temperature.

Fluorescent lamps are used to provide illumination for general lighting purposes because they are many times more efficient than incandescent light bulbs in producing visible light. A fluorescent lamp is a low pressure mercury vapor gas discharge device, from which visible light is produced when the phosphor layer coated on the inside of a hermetically sealed tubular glass bulb is activated by the ultraviolet radiation generated by an electron flow of a mercury vapor gas discharge formed within the tubular glass bulb when a proper electricity power is applied.

A plurality of electrodes are hermetically sealed into the tubular glass bulb of the fluorescent lamp for the purpose of starting and maintaining the electron flow when external electricity is applied to the electrical conducting wires linking at least one of the electrodes to the electronic driver that generates high voltage and high frequency electricity. These electrodes are designed for operating as either “hot” or “cold” cathodes, more correctly as “arc” or “glow” discharge electrodes, respectively. Fluorescent lamps having these two totally different discharge modes are commonly differentiated as the HCFL (hot cathode fluorescent lamp) and the CCFL (cold cathode fluorescent lamp), respectively. They belong to two totally different lighting technologies, because they use totally different mechanisms to generate electrons, i.e., by means of arc and grow discharges, respectively.

The HCFL operates in arc discharge mode needs a large current usually in the order of 0.1to 1.5 ampere to heat the tungsten coils attached to the “hot” cathodes to about 800.degree.C. to 1,000.degree.C., so that the electrons from the electron emission layer, usually in the form of alkaline earth oxides coated onto the tungsten wire, are excited and leave the electrodes to form into an arc discharge. As such, the HCFL is also known as an arc discharge lamp.

The life span of the HCFL ends when the electron emission layer is nearly evaporated by the high temperature of tungsten wire. The stress on the tungsten wire during the lamp's on-off instant is so severe that when the HCFL is flashing continuously, or when it is turned on and off frequently, the tungsten wire breaks easily. The tungsten wire also has a limited life as it weakens by its own continuous evaporation, same situation as the tungsten wire of an ordinary incandescent light bulb. These disadvantages render the HCFL a relatively short-life lighting device, with life span of usually a few thousands hours.

Another disadvantage of the HCFL is that its light output cannot be dimmed smoothly, as the tungsten wire needs a stable and high temperature to be maintained in order for it to continuously emit electrons from the electron emission layer. The dimming of the HCFL can therefore only be done in a stepwise manner by employing complicated and expensive electronic circuitry.

The CCFL emits electrons by a totally different mechanism from that of the HCFL, by making use of a high cathode-fall voltage usually of over 100V between the cathodes to pull ions into the gas discharge. This commonly known “grow” discharge mechanism is driven mainly by high frequency (10 k -150 kHz) AC electricity voltage of several hundred to a few thousand volts at start, and of 500-2,500 volts during operation. As the cathode-fall voltage needs to be high in order to obtain high efficacy and high power for general lighting purposes, the elongated lamp body of the CCFL is preferably of one meter long or more.

Despite the key disadvantage of having a fragile, long and thin lamp filament, the CCFL wastes no power to heat up the electrode during the start of the lamp. There is no evaporable tungsten, so its life span can be much longer than the HCFL, usually up to 50,000 hours or more.

The CCFL can operate on a continuous flashing mode, because of its “cold” electrode is usually formed of a coiled nickel plate with a large surface area that never evaporates or weakens as the tungsten wire of the HCFL does. The CCFL starts instantly (usually less than 10 milliseconds) even under low ambient temperature, due mainly to the fact that, unlike the HCFL, it does not need to heat up the tungsten wire to at least 800.degree.C. during start, which usually takes a several hundred milliseconds. Moreover, given the high operating voltage, dimming of the light output for the CCFL can be performed smoothly and instantly by reducing the voltage either gradually or swiftly to any desirable level by means of an ordinary wall dimmer.

Both the HCFL and the CCFL have been in existence for long time. They have many different applications and a large variety of products available in the market. As such, their comparative advantages and disadvantages, as well as their completely different technical aspects, are well known to people familiar with the art. It is therefore beyond doubt that the HCFL and the CCFL are essentially totally different lamp devices, even they share the same feature in exciting the mercury vapor to generate ultraviolet radiation for the phosphor layer to emit light.

Included here for reference purposes, there are detailed descriptions of the differences between the HCFL and the CCFL in the book “Flat Panel Displays and CRTS” by Lawrence E. Tannas, Jr., (Von Nostrand Reinhold, New York, 1985), in the paper entitled “Efficiency Limits for Fluorescent Lamps and Application to LCD Backlighting,” by R. Y. Pai, (Journal of the SID, May 4, 1997, pp. 371-374), and in the descriptions of prior arts contained in U.S. Pat. No. 5,834,889, granted to Ge, Nov. 10, 1998; U.S. Pat. No. 6,135,620, granted to Marsh, Oct. 24, 2000; and U.S. Pat. No. 6,515,433, granted to Ge, et al., Feb. 4, 2003.

The major advantages of the CCFL over the HCFL for the more compact size, longer life span, being dimmable, being able to flash continuously, and etc., should have long enabled the CCFL to be more widely used than the HCFL in many different lighting applications. Nevertheless, the reality is that the CCFL is so far only most frequently used in the back light module for the viewing screen of note book computers, LCD TVs, flat panel displays, and for the exit signs, where the electricity power required for these applications are only several watts. The back light modules of large LCD TV screens and other large format displays need a few CCFLs operating together, but each component CCFL still operates at several watts only.

The most important shortcoming of the conventional CCFL device is that it cannot normally operate at a high electricity power input due mainly to over heating. The luminous efficacy of the CCFL decreases sharply when the body temperature of the lamp filament rises with the increase of electricity power input, particularly when the CCFL device lacks an efficient heat dissipation means.

In applications for general lighting purpose, where a bulb shaped lamp of similar size to an ordinary Incandescent light bulb is desirable, the HCFL consistently dominates the market as the preferred gas discharge device, mainly because a compact bulb-shaped HCFL is usually able to operate at significantly higher power at 10-30 watt per lamp, and a non-compact HCFL such as the T12 tubular lamps is able to operate at 60 W or more.

In contrast, mainly because of the unresolved over-heating difficulty of the CCFL to operate at higher electricity power input, a CCFL in a compact form factor with a bulb-shaped container can normally operate up to 7 watt. Yet at such lower electricity power input, the length of the CCFL is not long enough to allow the CCFL to operate with sufficiently high cathode-fall voltage, resulting in significantly lower light output efficiency than the HCFL.

Another major shortcoming of the conventional CCFL device comes with the physical fragility of its elongated lamp filament, which cannot normally be acceptable for general lighting applications in a bare lamp form factor without a light-transmitting container, even if the filament is bent into a spiral or a double-spiral. Moreover, being coverless also raises another unpleasant shortcoming, because phototactic insects would be trapped and died inside the narrow pitches of the exposed lamp filament spiral. In order to protect the thin CCFL filament from mechanical and vibration shocks, it is therefore desirable to enclose it within a light-transmitting container, which acts both as a protecting shield, and also enables the device to look similar to an ordinary light bulb.

Although it is necessary and desirable to enclose the CCFL filament in a light-transmitting container in order for it to function safely as a lighting device with a customary light bulb outlook, it brings a major shortcoming attributing to poor light-output efficiency. The CCFL filament generates considerable heat under an enclosed environment where heat is not easily dissipated, and this causes the temperature with the container to rise significantly and stops the CCFL gas discharge device to function efficiently, due mainly to a peculiar behavior of the mercury vapor inside the CCFL filament that is overheated.

Last but not least, another shortcoming of the conventional CCFL device is that its electronic driver usually comprises 2 bulky transformers and a large toroidal transformer so it is normally too big, and a housing is therefore needed to contain the electronic driver. This makes it difficult to have a CCFL device in a small form factor similar to an ordinary incandescent light bulb. It is therefore highly desirable to provide a bulb-form CCFL device that has an electronic driver small enough to fit mostly inside the lamp base.

### BRIEF SUMMARY OF THE INVENTION

An improved CCFL gas discharge device is provided according to the present invention that comprises a light-transmitting container housing at least one CCFL filament inside and an electronic driver providing high frequency of 10 k -150 kHz and high voltage electricity of 500-2,500 volts is electrically connected to the electrodes of the CCFL. Said CCFL filament uses a principal amalgam to control the mercury vapor pressure inside its glass envelope so that it can generate optimum light output while being enclosed inside a light-transmitting container with high ambient temperature

An object of the present invention is use the principal amalgam alone to regulate the mercury pressure inside CCFL filament, so that it can generate high intensity illumination at high ambient temperature. Said principal amalgam is placed inside a small tabular adheres to and communicates directly with the electrode through a common passage, and it is separated from the electrode by a small glass bead or a amalgam connection member immediately in between. Nevertheless, in case a high melting point principal amalgam is used, it is attached next to the electrode without the glass bead or a amalgam connection member in between. Alternatively, such a high melting point principal amalgam is formed into a wire, a pallet or other forms that is wrapped around the electrode or is embedded inside the electrode.

For the novel CCFL device according to the present invention that uses amalgam to control the mercury vapor pressure, unlike the HCFL, there is no auxiliary amalgam being used, and the principal amalgam is solely responsible to control the mercury vapor pressure within the CCFL filament. In order for the mercury molecules trapped inside the principal amalgam to be released swiftly during lamp start, it must be heated up to at least 70.deg.C. the soonest possible after the lamp start if it is a low-melting point amalgam, or else it must be heated up to at least 100.deg.C. if it is a high-melting point amalgam.

As the only heat source within the CCFL filament is the “cold” cathode, which normally operates at about 60.deg.C. during lamp start and up to as much as 110.deg.C. afterwards. As such, the lowest possible melting point amalgam is usually used and placed as closest to the electrode as possible, so long as it does melt during the operation of the CCFL device. With a glass bead or a amalgam connection member in between, the principal amalgam takes more time to be heated up before start releasing the mercury molecules, but as the heat from the electrode is not directly passed to the principal amalgam when the glass bead or the amalgam connection member is in between, the lower melting point amalgam can therefore control the mercury vapor pressure at higher operating temperature than the case without the glass bead or the amalgam connection member in between.

For a higher power device, a higher melting point amalgam must be used, but it needs a higher starting temperature in order to release the mercury molecule. As such, it is placed right next to the electrode. Its higher melting point allows it to stay as a solid without being melted down by the high temperature of the electrode.

More preferably, when a high melting point principal amalgam is used, the electronic driver has a fast start circuitry according to the present invention, so that the electricity power passing to the electrodes during the first few minutes of at the lamp start would be substantially higher than the normal operating power input for the device, allowing the principal amalgam to release the mercury molecules at the soonest possible time after the lamp start.

Another object of the present invention is to devise a fast start circuitry in the electronic driver that allows the CCFL to reach optimum intensity within two minutes of start in case when a high melting point principal amalgam is used. Said fast start circuitry comprises one auxiliary high voltage transformer connected in parallel with the principal high voltage transformer of the electronic driver. A PTC or other timer device attached to the auxiliary high voltage transformer cuts off the input electricity power to the latter within a few minutes after the lamp starts.

Another object of the present invention is to reduce the complexity of the driver circuit so that it uses fewer components and is more compact. This object is accomplished by using a complimentary pair of PNP and NPN transistors to allow the low voltage transformer that outputs low voltage AC current to the high voltage transformers. In a conventional circuit when only the NPN transistors are used, a bulky ring-type toroidal transformer is required to switch the current from DC to AC. Use of the complimentary PNP/NPN transistors eliminates the need for the toroidal transformer and therefore greatly reduces the complexity of the driver circuit, the size of the electronic driver as well as the associated manufacturing cost.

All the above and other objects, features, and advantages of the present invention will become apparent from the following detailed description of the different embodiments of the present invention, the accompanying drawings, and the enlisted claims. While not specifically described, it is understood that many of the features in the different embodiments may be used separately or in conjunction. Thus, different spiral shaped CCFL filaments may be employed in any one of the above-described embodiments, the principal amalgam placed next to the electrode may be employed in any one of these embodiments, and the protective material attached to the CCFL filament can also be applied to any one of the above embodiments.

Similarly, the light-transmitting container of a small form factor may be A-shaped, pear-shaped, candelabra-shaped, globe-shaped, cylindrical-shaped, cone-shaped, MR16, MR103, and any other shapes commonly taken on by an ordinary incandescent light bulb. The material used to form the container can be glass, plastic, resin or metal coated with a reflective inner surface, or a combination of these different materials. Moreover, the tubular glass bulb is bent into different shapes of U's serpentine, cone spisal, double spiral and the like, so that the ultimate gas discharge fluorscent device has a small form factor of shape and size similar to an incandescent light bulb.

Additionally, each of the embodiments may employ more than one CCFL filament. In cases where two or more filaments are used, each may generate light of the same or different colors. The CCFL devices may be used for illumination, decoration, traffic lights or display devices for displaying information of different types, All such variations are within the scope of the present invention.

### BRIEF DESCRIPTION OF THE SEVERAL VIEWS OF THE DRAWINGS

The foregoing summary and the following detailed description of the invention will be better understood when read in conjunction with the accompanying drawings. For the purpose of illustrating the present invention, only the presently preferred embodiments are shown in the drawings, but it should be understood that the invention is by no means limited to the precise arrangements and instrumentalities shown in the drawings, which are briefly introduced below:

FIG. 1 is the graph of the mercury vapor pressure inside the low mercury vapor gas discharge device at different coolest body temperatures of said device, for seven different types of principal amalgams, comparing with the case where only pure mercury is placed inside the gas discharge device.

FIG. 2 is the cross-sectional view of a CCFL filament that has a principal amalgam placed in a small tubular next to the electrodes that communicates directly with the inner space of the filament, and the principal amalgam is separated from the electrode by a small glass bead.

FIG. 3 is the cross-section view of a CCFL filament similar to that of FIG. 2 except that the principal amalgam is attached immediately next to the electrode without a small glass bead in between.

FIG. 4 is the cross-section view of a CCFL filament similar to that of FIG. 3 except that the principal amalgam is wrapped outside the electrode.

FIG. 5 is the cross sectional view of a CCFL filament similar to that of FIG. 4 except that the principal amalgam is placed inside the electrode.

FIG. 6 is the cross-section view of a CCFL device with a CCFL filament similar to that of FIG.3 that has the principal amalgam attached immediately next to the electrode without a small glass bead in between.

FIG. 7 is the cross section view of a CCFL plug-in lamp with a G23 electrical connector, and with a CCFL filament similar to that of FIG. 4 that has the principal amalgam wrapped outside the electrode.

FIG. 8 is the cross-section view of a CCFL tubular lamp with G13 electrical connectors at both ends of its tubular light transmitting container, and with a CCFL filament similar to that of FIG. 4 that has the principal amalgam wrapped outside the electrode.

FIG. 9 is the block circuit diagram of a high-voltage and high-frequency electronic driver circuit for CCFL device according to the present invention, which has an auxiliary high-voltage transformer controlled by a PTC/timer device, and which uses a complimentary pair of PNP/NPN transistor.

### DETAILED DESCRIPTION OF THE INVENTION

Hereinafter, the details of the present invention and its preferred embodiments are described with reference to the accompanying drawings. In the accompanying drawings, for simplicity in description, identical components are labeled by the same numerals, which start from 101.

Embodiment 1

An embodiment of the present invention devises a method that uses the principal amalgam alone to regulate the mercury pressure inside its discharge tube, so that it can generate high intensity illumination at high electricity power input. The principal amalgam can be one of those commonly used principal amalgam of the HCFL, and is placed inside a small tabular adheres to and communicates directly with the electrode through a common passage.

Both the CCFL and the HCFL are low mercury vapor pressure gas discharge devices, they share most of features at their post-electron generation activities. In particular, they share the same light-generating mechanism by having the mercury molecules being excited by the electrons to a higher energy state, from which they return to the ground state and produce ultraviolet radiation. The ultraviolet radiation is absorbed by the phosphor layer on the CCFL filament wall, and is finally converted into visible light and heat. During the ultraviolet radiation generation phase, the mercury gas discharge works efficiently (i.e., generates the optimum amount of ultraviolet energy) only when the coolest spot of the CCFL is within a temperature range of about 25-75.degree.C. Above this temperature range, the excessive heat will cause the mercury ions to become overly active so that the mercury vapor pressure within the CCFL increases.

As explained in a pioneer research titled “Amalgams for fluorescent lamps”, by Bloem, et al., published in the Philips Technical Review (Volume 38, 83-88 1978/79 No. 3), the mercury vapor pressure is an important parameter for a low pressure mercury discharge device, and it is usually determined by the coolest part of the lamp wall. If this pressure is too low, few mercury molecules are excited, meaning insufficient ultraviolet radiation falls on the phosphor layer. If it is too high, the mercury molecules absorb much of their own radiation and more of them become in excited states, and there becomes a greater probability of interactions involving non-radiative transfer of their excitation energy, so less ultraviolet energy lands on the phosphor layer.

On page 23 of the book “Electric discharge lamp” by JF Waymouth (MIT Press Cambridge Mass. 1971), it is told that the optimum mercury vapor pressure is approximately 6×10.sup.-3 torr, a value reached when the coolest spot on the wall of the lamp is about 40.deg.C. Nevertheless, with mercury vapor pressure at between about 3×10.sup.-3 torr and 9×10.sup.-3, the lamp's light output efficiency is still within an acceptable level that is not too noticeably different from the optimal light output level at mercury vapor pressure of about 6×10.sup.-3 torr.

Both the CCFL and HCFL share the same difficulty of poor light output efficiency when excessive heat raises the mercury vapor pressure within their gas discharge tubes. For the HCFL, because of its substantially longer history in general-lighting uses, there are plentiful prior arts teaching effective solutions for it to overcome the excessive heat difficulty by using both the auxiliary and the principal amalgams within its lamp filament. Using both said amalgams, HCFL can control the mercury vapor pressure at its optimal working range even when the ambient temperature of the HCFL is raised beyond the 75.degree.C.

For the auxiliary amalgam, it is well known in the art that it is usually in the form of a thin layer of indium element coated on a tiny nickel or stainless steel sheet attached next to the tungsten wire of the “hot” cathodes in the HCFL.

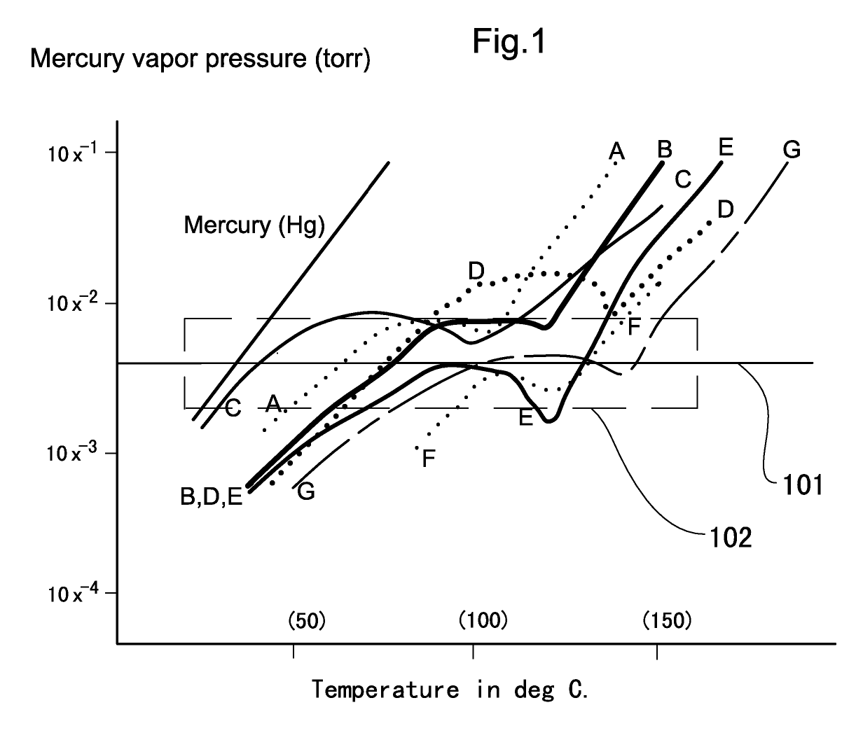

For the principal amalgams, the pioneer invention by Bloem et al. in the US Pat. No. 4,093,889, granted Jun. 6, 1978, teaches the use of a principal amalgam comprising bismuth, tin and lead. Since then, many prior arts further invent new compositions and means for the use of the principal amalgams in the HCFL, such as the US Patents No. 4615846, 4924142, 4972118, 5952780 and EP-B1-0157440, just to name a few. The extents to which these principal amalgams can control the mercury vapor pressure are illustrated in FIG. 1, and are further explained below.

The principal amalgam is usually in the form of a small pallet placed preferably at the farthest distance away from the HCFL electrodes. The function of the principal amalgam is to absorb mercury vapor from the gas discharge when the mercury vapor pressure become excessive, after the coolest lamp body temperature rises to between 75.deg.C. to 150.deg.C. When an appropriate amount of mercury is absorbed by the main amalgam, the ultraviolet radiation generation activity by the HCFL will return to the optimal level even if the coolest wall temperature of the lamp is still higher than 75.degree.C.

However, if there is no auxiliary amalgam, mercury absorbed by the main amalgam will continue to remain trapped inside the main amalgam pallet after the lamp is turned off, so that when the lamp re-starts after cooling down, there will be insufficient mercury to starting the lamp again. Nevertheless, under this circumstance, the auxiliary amalgam presents in the HCFL will totally replenish the mercury supply during lamp start. The auxiliary indium amalgam has a much greater affinity for mercury than the principal amalgam, so it will attract most of the mercury molecules to its surface after the lamp is turned off. It even “pulls” most of the mercury trapped by the principal amalgam to itself after the lamp is turned off. When the HCFL is turned on again, the high temperature of the “hot” cathode (at 800-1,200.degree.C.) will melt the indium amalgam nearby within a couple hundreds of milliseconds after lamp start, thereby releasing all mercury molecules it trapped to the gas discharge.

Without the auxiliary indium amalgam, the HCFL can only start very slowly after the lamp is turned on. This is because the main amalgam will continue to trap most of the mercury molecules in the gas discharge tube, until the arc discharge gradually heats it up to the temperature of about 70-80.deg.C. before it starts to release mercury slowly, so that the HCFL will not reach its optimum light output until a few minutes of lamp start.

Moreover, within the HCFL filament, the principal amalgam cannot be placed near the “hot” cathodes, as the temperature is so high at above 800.deg.C. that will exceed the even highest melting point of less than 200.deg.C. for any principal amalgam known to the art. As such, the principal amalgam of the HCFL devices are usually placed at the farthest possible position away from the “hot” electrode with a separating distance of at least 15 millimeters, so that it can function properly without being melted down when the HCFL device is operational at its full power rating. Nevertheless, being located far away from the “hot” cathodes, the principal amalgam will not be heated up to about 70-80.deg.C. until a few minutes after the lamp start, and therefore will not be able to release the mercury molecules it traps during the first few minutes of the lamp start.

For the HCFL, the auxiliary amalgam and the principal amalgam therefore form a perfect partner to control the mercury vapor pressure. The auxiliary amalgam is attached as closest to the hot cathode as possible, whilst the principal amalgam is disposed farthest way from the same electrode. The auxiliary amalgam is responsible for supplying the mercury molecules during lamp start, and the principal amalgam is responsible for absorbing the mercury molecules when the ambient temperature of the HCFL filament is raised beyond the optimum temperature range. The auxiliary amalgam will also collect most of the mercury molecules to it after the device is switched off, and even pulls most of the mercury molecules trapped by the principal amalgam after the device is cooled off.

Although the HCFL can successfully use the auxiliary and the principal amalgam simultaneously to control the mercury vapor pressure at high ambient temperature, it is not the case for the CCFL. Unlike HCFL, the CCFL cannot use the auxiliary amalgam because its electrode is not hot enough to melt the auxiliary indium amalgam, as its “cold” cathode normally starts at a temperature of about 60-70.degree.C. Even the CCFL operates at higher electricity input power, the cold cathode seldom starts at temperature of over 120.degree.C., falling short of the melting temperature at 157.degree.C. for the indium amalgam to release the mercury molecules.

Except for the indium auxiliary amalgam, there is no other of auxiliary amalgams for use by any low pressure mercury vapor gas discharge device, be it HCFL or CCFL. More precisely, there is no other alternative substance known to the art that can absorb the mercury molecules after the lamp is turned off and then releases the mercury molecules swiftly at lamp start. As such, same as the HCFL, when there is no auxiliary indium amalgam, and when the principal amalgam is used alone, the CCFL operating at high power input cannot start swiftly, and will not reach its designed light output level until a few minutes after the lamp starts.

Fortunately, the present invention has found a novel means that satisfactorily solves the difficulty of using the principal amalgam alone for the CCFL devices. This requires that no auxiliary amalgam be used, so that only the principal amalgam can be placed inside the CCFL filament. Besides, a careful selection of the principal amalgam must be made for different CCFL devices with different power input, which therefore have different operating temperature for the CCFL filament when the device is fully operational.

No auxiliary amalgam, i.e., the indium amalgam is placed inside the CCFL filament because it continues to absorb mercury amalgam so long as its temperature is about 10-15 deg C. below its melting point of 157.deg.C., as indium has big affinity for mercury until it is heated up to about 10-15.deg.C. below its melting point, and the lower the temperature, the faster the mercury absorption. As such, when both the auxiliary and the principal amalgams are in place, the mercury released by the principal amalgam after lamp start would be mostly absorbed by the auxiliary amalgam. This is a totally different scenario from that of the HCFL, which can be easily explained by the fact that there is not such “hot” spot inside the CCFL filament that can stop the indium absorbing mercury at below 140.deg.C.

Also contrary to the HCFL, inside the CCFL, the principal amalgam must be placed as closest to the “cold” cathode as possible, i.e., the distance between the nearest surfaces of the principal amalgam and the electrode is less than 15 millimeters, and preferably zero so long as the principal amalgam is not melted by the heat of the “cold” cathode, in which case the principal amalgam is in touch with the CCFL electrode. In this manner, the principal amalgam relies upon the only heat source within the CCFL filament, i.e., the “cold” cathode to release the mercury molecules it trapped during the lamp start.

If the principal amalgam is in the form of a wire or a bendable plate, it can be wrapped around the CCFL electrode, or it can be wrapped together with the electrode when the electrode is also formed of a metal plate coiled into a cylindrical shape. Moreover, if the principal amalgam is in the form of a small pallet or any other shape with an elongated surface, it can be placed inside the CCFL electrode. However, it doing so, the principal must have a higher melting point that it can remain in solid form notwithstanding the heat of generated from the electrode.

The selected principal amalgam must have the best suitable and lowest possible melting point that allows it to release the molecule the soonest after the lamp start, and to absorb the mercury molecules when the lamp filament becomes too hot. As a rule, the lower the melting point, the lower the start-up temperature for it to release the mercury molecules. However, a lower melting point principal amalgam loses its control over the mercury vapor pressure when it is melted down or is about 10-15.deg.C. below its melting temperature. Once melted, or close to being melted, the principal amalgam will not absorb any mercury molecules, but rather releases all of them to the gas discharge.

Therefore, according to the present invention, a higher melting point amalgam is usually used, and in order to compensate for the longer time for it to release the mercury molecule during lamp start, a fast start circuitry is employed in the electronic driver that allows the device to start at a much higher power rating than the device is originally designed for. Such a higher than normal power input will only be maintained within the first few minutes after the lamp start, as after that, the extra-power supplied to the lamp filament by the electronic driver is then terminated or reduced significantly. With the much higher power input during lamp start, the “cold” cathodes is heated up faster to the level that will allow the principal amalgam attached or nearby to release the mercury molecules. The much stronger current surrounding the electrode due to the increased power input will also help to pull the mercury molecules away from the principal amalgam faster.

Furthermore, if a lower melting point principal amalgam is selected for the lower power CCFL device, it might not be necessary to employ the fast start circuitry described in the above. So long as the principal amalgam is not melted down, the device can still produce its optimum luminous intensity. In this situation, it is desirable to separate the principal amalgam from the electrode by a small glass bead or other amalgam connection member immediately in between, which will avoid the principal amalgam melting even the electrode temperature rises somewhat above the melting point of the amalgam, as the glass bead or the amalgam connection member is a poor thermal conductor.

However, when a high melting point principal amalgam is used, it can be attached right next to the electrode without a glass bead or a amalgam connection member in between. Alternatively, a high melting point principal amalgam can be in the form of a metal wire of other shapes wrapping around the electrode on its external surface, or in the form of a bead or other shapes being placed partially or wholly inside the electrode. In case the high-melting point principal amalgam is used, it is always desirable to employ the fast start circuitry for the CCFL device.

The above manner of disposing the principal amalgam within the CCFL filament according to the present invention, is totally different from the way it is used in the HCFL devices, where the principal amalgam is placed as far away from the electrode as possible. Whilst placing the principal far away from electrode is appropriate for the HCFL, it is teaching away from the present invention that is for a CCFL device.

Referring to FIG. 1, the graph shows the mercury vapor pressure within a gas discharge device that seven different principal amalgams A to G are able to control, at various temperatures of the coolest spot of the device. It also shows the same mercury vapor pressure within the device when only pure mercury is present. The horizontal line 101 shows the optimum mercury vapor pressure of approximately 6×10.sup.-3 torr for all low mercury vapor pressure gas discharge devices, as taught on page 23 of the book “Electric discharge lamp” by JF Waymouth (MIT Press Cambridge Mass. 1971).

The region 102 bounded by dashed line shows at mercury vapor pressure at between about 3×10.sup.-3 torr and 9×10.sup.-3, where the device is still able to produce light output acceptably so that is not too noticeably different from the optimal light output level at mercury vapor pressure of about 6×10.sup.-3 torr. At this pressure range, as indicated by the horizontal range of region 102, the lower melting point principal amalgam C and A work well for temperature range of about 29-113.deg.C. and 48-108.deg.C., respectively; the medium melting point amalgams B, D and E work well for temperature ranges of about 61-122.deg.C., 64-89.deg.C., and 70-137.deg.C., respectively; and the higher melting point amalgams G and F work well for temperature range of about 79-152.deg.C. and 95-142.deg.C., respectively.

Six of the seven principal amalgams (A to D and F to G) above are taught by the various prior arts teaching the HCFL amalgam, and the remaining principal amalgam E is a conventional one commonly used in the HCFL devices.

The principal amalgam A is taught by the U.S. Pat. No. 4,972,118, with weight composition of 54% bismuth, 41% lead and 5% mercury.

The principal amalgam B is taught by the U.S. Pat. No. 4,972,118, with weight composition of 56% bismuth, 43% lead and 1% mercury.

The principal amalgam C is taught by the U.S. Pat. No. 4,615,846, with weight composition of 58% bismuth, 16% tin, 16% indium and 10% mercury.

The principal amalgam D is taught by the U.S. Pat. No. 4,972,118, with weight composition of 52% bismuth, 42% lead, 3% indium and 3% mercury.

The principal amalgam E is the conventional one with weight composition of 64% bismuth, 32% indium and 4% mercury.

The principal amalgam F is taught by the U.S. Pat. No. 4,924,142, with weight composition of 80% indium, 16% tin, 2% zinc and 2% mercury.

Finally, the principal amalgam G is taught by the U.S. Pat. No. 4,972,118, with weight composition of 56.2% bismuth, 43.3% lead and 0.5% mercury.

There are many various available principal amalgams that are functioning similarly to the above selected principal amalgams, and they all comprise a pre-determined combination of at least one of the mercury, lead, bismuth, zinc, indium, tin, silver, gold, platinum, and other metallic elements. As there are too many of these possible combinations, it would be too tedious to describe all of them. We have therefore only selected the eight most representative ones in the above analysis.

For CCFL devices operating at 7 watt or below, they does not normally need to use the principal amalgam, as filling the high thermal conductivity gas within the light-transmitting container will suffice. For the CCFL devices operating at 8-10 watt, using the C-type or A-type principal amalgam in the manner described above could allow the device to generate high illumination intensity optimally, even without filling a high thermal conductivity gas inside the light-transmitting container. However, with the high thermal conductivity gas while at the same time using the C-type or A-type principal amalgam in the manner described above, optimum light output can still be achieved even when the CCFL device operates up to 10-13 watts.

Above 13 wattages, the higher-melting-point principal amalgams, such as the B-, D- or E-type principal amalgam, should be used in conjunction with the high thermal conductivity gas within the light transmitting container. The higher-melting-point amalgams will cause the device to achieve full intensity considerably slower, by a few minutes. Nevertheless, a fast start circuitry for the electronic driver described in Embodiment 2 below can allow devices using the higher-melting-point amalgams to start releasing sufficient mercury molecules within two minutes of lamp start.

It is generally not necessary to use the above G-type and F-type principal amalgams unless the wattage of the CCFL device is higher than 18 watts, and in this case a fast start circuitry for the electronic driver described in Embodiment 2 must be used in order to allow the device to generate light output at its optimum level within two minutes of lamp start.

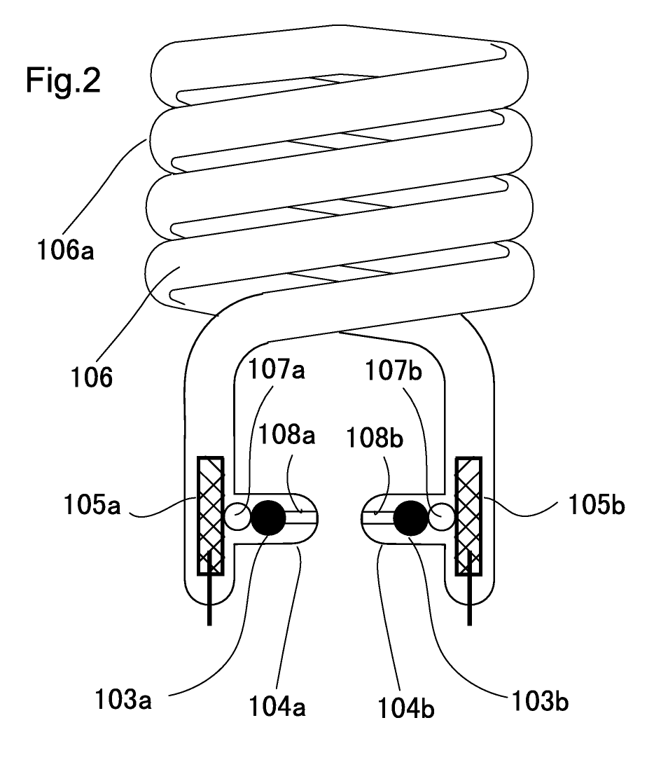

Referring to FIG. 2, the principal amalgams 103a and 103b are placed inside a small tabular 104a and 104b respectively. The principal amalgams 103a and 103b are adhering to and communicate directly with the electrode 105a and 105b of the CCFL filament 106 through a common passage inside the glass envelope 106a of CCFL filament 106. Moreover, the principal amalgam 103a (103b) is separated from (i.e., not touching) the electrode 105a (105b), as a small glass bead 107a (107b) of a diameter less than the internal diameter of the tubular 104a (104b) is placed in between and with their surfaces contacting each other. Inside the tabular 104a (104b) housing the principal amalgam 103a (103b), on the opposite side of the amalgam facing away from the electrodes 105a (105b), a glass rod 108a (108b) of outer diameter smaller than the inner diameter of the tabular 104a (104b) is used to fix the position of the principal amalgam 103a (103b): one end of the glass rod 108a (108b) is bonded together with the end of the said tubular 104a (104b), and its other end is directly in touch with the principal amalgam 103a (103b). In this manner, even there is no auxiliary amalgam being used, the principal amalgam 103a and 103b alone can still allow the improved CCFL filament 106 to generate high intensity illumination when operated under high electricity power input in an enclosed environment, disregarding whether or not the container is filled with a high thermal conductivity gas.

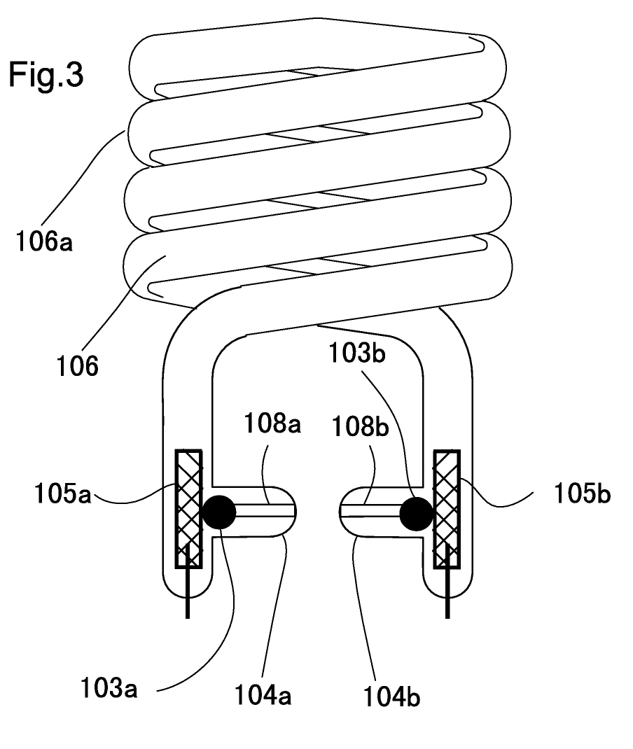

Referring to FIG. 3, the arrangement of the amalgam placement is almost the same as that of FIG. 2, with the principal amalgam 103a and 103b being placed inside a small tabular 104a and 104b, that are adhering to and communicates directly with the electrode 105a and 105b, respectively, of the CCFL filament 106 through a common passage. However, the principal amalgam 103a (103b) in this case is high-melting point amalgam that would not be melted by the heat of the electrodes 105a (105b) right next to it, and as such, it is no longer separated from the electrode by a glass bead or a amalgam connection member.

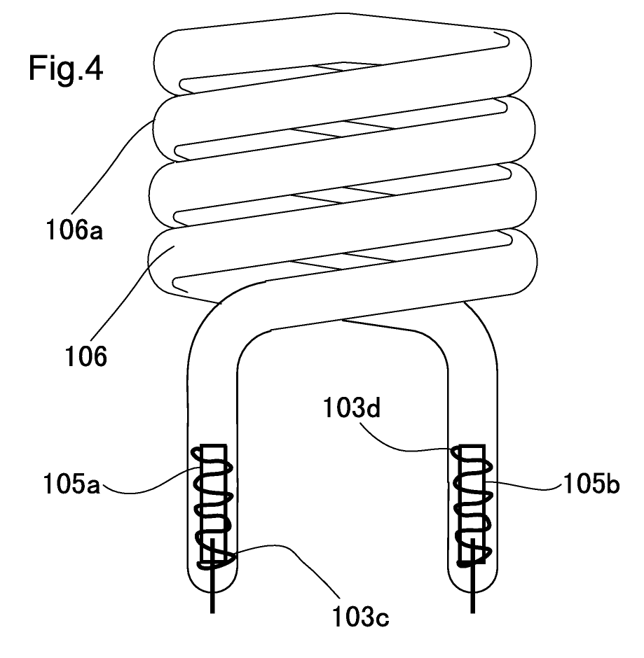

Referring to FIG. 4, the high temperature principal amalgam 103c and 103d are in the form of metal wires wrapping around the electrodes 105a and 105b of the CCFL filament 106, respectively.

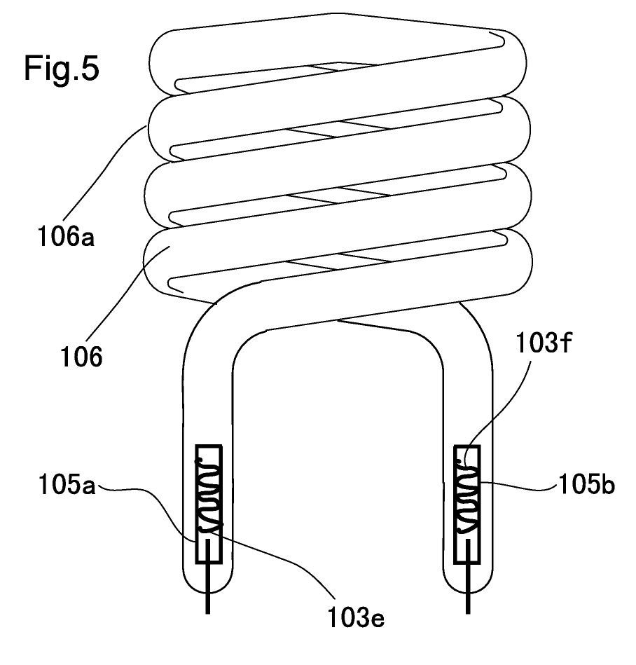

Referring to FIG. 5, the high temperature principal amalgam 103e and 103f in the form a metal wire is placed wholly inside the electrode 105a and 105b of the CCFL filament 106.

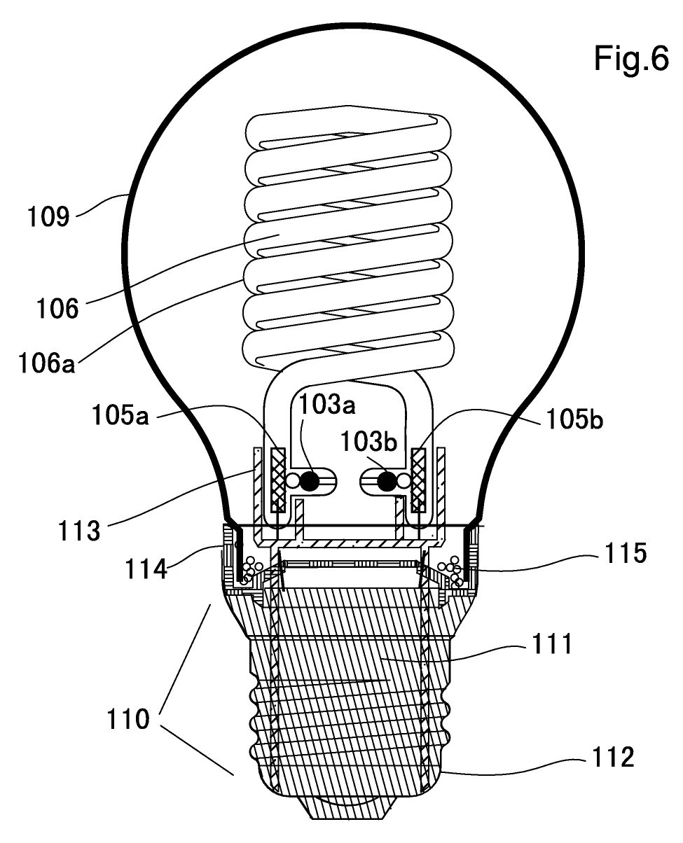

Referring to FIG. 6, it shows the cross-sectional view of a fully assembled CCFL device with a principal amalgam 103a and 103b attached to the electrodes 105a and 105b inside the glass envelope 106a of lamp filament 106 in the same manner as described in FIG. 2 above. This is one typical example of a CCFL filament with the novel principal amalgam feature of the present invention, and there are numerous variations as to how such a CCFL filament can be attached to an electronic driver, or to an integral ballast assembly in order to generate high luminous output at high electricity power input. For a typical CCFL device shown in FIG. 6, the light transmitting container housing 109 houses at least one CCFL filament 106, and its integral ballast assembly 110 is embedding the electronic driver (not shown) inside the heat conductive compound 111. The integral ballast assembly 110 is also formed integrally with lamp base 112 that is for mechanically and electrically coupling to a conventional power socket, with a lamp filament support member 113 that is attaching to and supporting the CCFL filament 106, and with the container connection member 114 that is attached to the light transmitting container 109 by bonding agent 115 that comprises a silicone adhesive, a RTV or a low melting point soldering glass.

CCFL filaments with the principal amalgam structured according to the present invention can also be used for any kind of CCFL devices that do not form together with their own electronic drivers, but are rather connected to external electronic drivers in order to operate the CCFL filaments. These include the CCFL plug-in lamps that use the G23, G24 or G24d electrical connectors, and the CCFL T5, T8, T9 and T12 lamp tubes that use G5, G13 or R17d bi-pin electrical connectors.

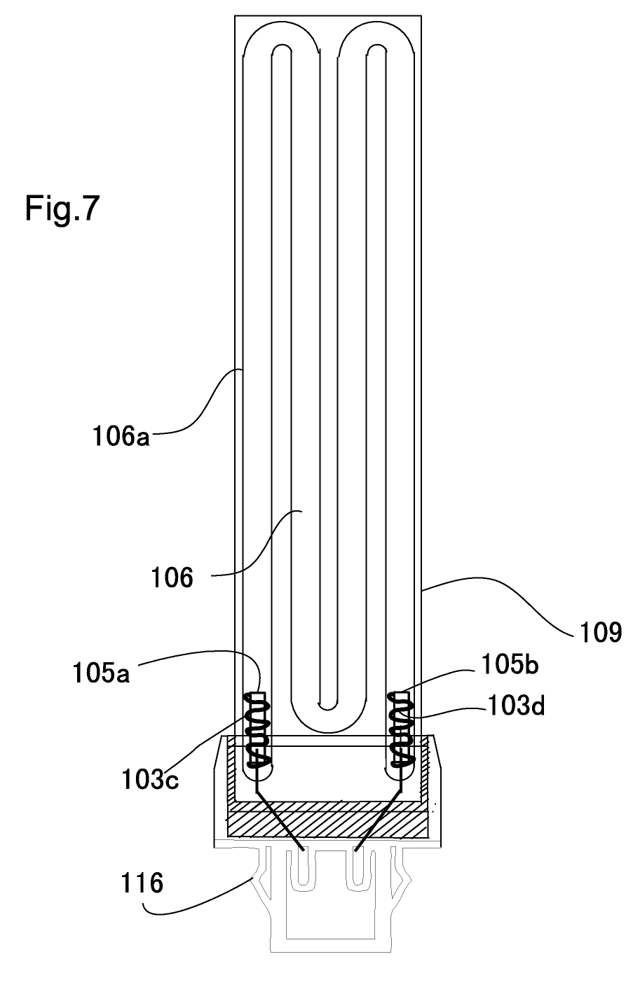

Referring to FIG. 7, it shows a CCFL plug-in lamp with a G23 electrical connector 116 and a CCFL filament 106 housing inside light transmitting container 109 that has principal amalgams 103c and 103d in the form of metallic wires wrapping around the electrodes 105a and 105b, respectively, inside the glass envelope 106a of CCFL filament 106.

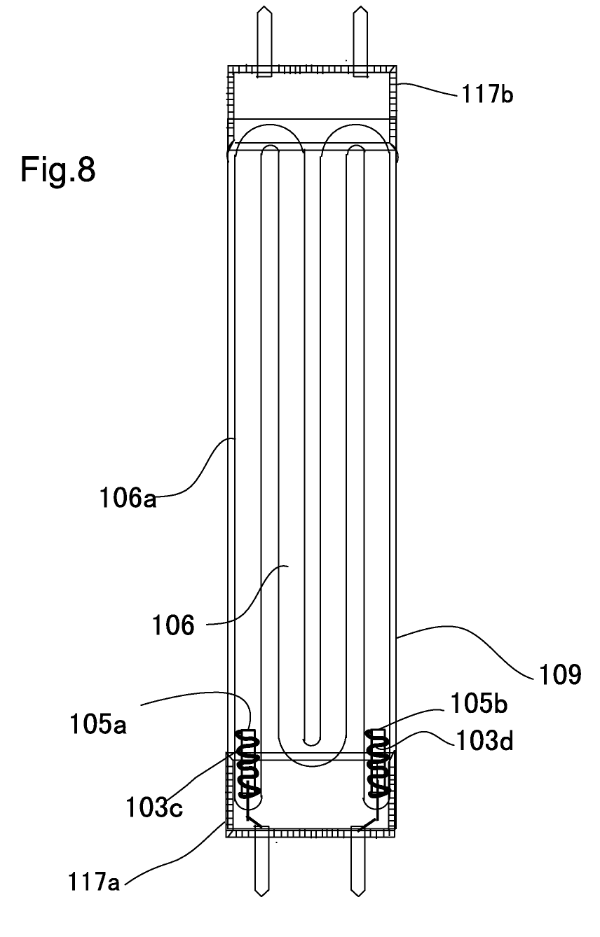

Referring to FIG. 8, it shows a CCFL tubular T12 lamp with a G13 electrical connector 117a and 117b and a CCFL filament 106 that has principal amalgams 103c and 103d in the form of metallic wires wrapping around the electrodes 105a and 105b, respectively.

Embodiment 2

Another object of the present invention is to devise a fast start circuitry in the electronic driver for an improved CCFL device that allows it to reach its optimum luminous intensity within about 2 minutes of start when a higher-melting-point principal amalgam is used, and when the device is operating at higher electricity input power of more than 10 watt. The higher-melting-point principal amalgam is usually more difficult to release mercury during lamp start, as it needs a higher starting temperature to expel the mercury molecules it traps. Nevertheless, applying a higher initial operating power during lamp start can cause the electrodes of the CCFL filament to raise its temperature faster, and at the same time a more intensive electron flow can be formed, thereby pulling the mercury molecules from the principal amalgam faster. As such, when using the higher-melting-point principal amalgam, by raising the input power of the device during lamp start by at least 10% (preferably 100-120%) higher than the device's original power rating, the optimum light intensity can be reached within two minutes after the lamp start.

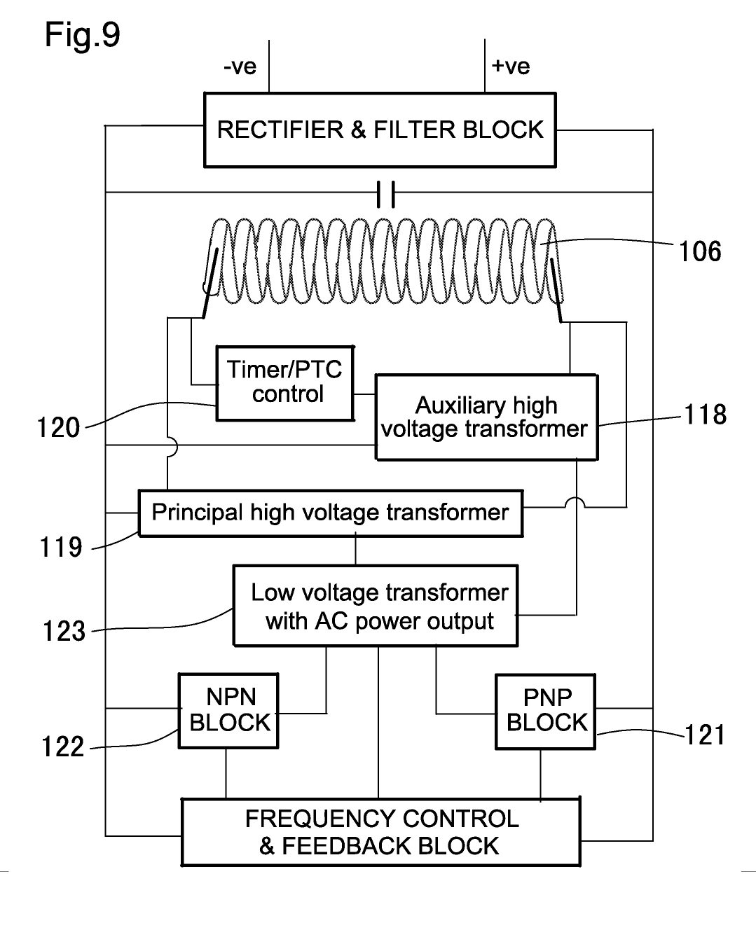

Referring to FIG. 9 that shows the block circuit diagram of the fast-start electronic driver according to the present invention, it has an auxiliary high voltage transformer 118 operating at parallel with the principal high voltage transformer 119. A PTC or timer control block 120 is attached in series to auxiliary high voltage transformer 118 so its input power will be cut off within a few minutes after the lamp start by the timer/PTC control block 120. As such, the auxiliary high voltage transformer 118 only functions during the initial stage when the lamp starts, when it increases the initially wattage of device by at least 10% over its normal power level.

The timer/PTC control block 120 can use a PTC (positive temperature coefficient) resistor connected in series with the auxiliary high voltage transformer 118. It is disposed near to an electrode of the CCFL filament, so when it reaches certain pre-determined temperature within a few minutes after the lamp start, its cuts off the electricity power to the transformer 118. Alternatively, the PTC/timer control block 120 can use a NTC (negative temperature coefficient) resistor connected in parallel to the auxiliary high voltage transformer 118. The NTC blocks the electricity from passing itself during the first few minutes after lamp start, so the auxiliary high voltage transformer 118 connected in parallel receives the low voltage electricity current and transforms it into a high voltage one for the CCFL filament 106. Then the NTC resistor becomes an extremely low resistance resistor after its temperature rises a few minutes after the lamp start, so current will passing itself instead of through the auxiliary high voltage transformer 118, effectively switching off the power supply for the auxiliary high voltage transformer 118. Furthermore, the PTC/timer control block 120 may also use other timing device such as the well-known “555” IC or other timer IC to control the switch-off time for the auxiliary high voltage transformer 118 precisely at a pre-determined time after the lamp start.

Embodiment 3

Another embodiment of the present invention uses a complimentary pair of PNP and NPN transistors to reduce the complexity of the driver circuit so that it uses fewer components and also eliminates a bulky toroidal transformer which must be used in order for the low voltage transformer to switch the rectified DC current into an AC one. This complimentary PNP/NPN pair of transistor works in a push-pull manner so when a DC current passing through them simultaneously to the low voltage transformer, the DC current will be switched from a low frequency low voltage input DC current of frequency below 1 kHz to a high frequency low voltage output AC current of frequency between 10 kHz to 150 Hz.

Whereas in conventional devices, a pair of NPN transistor is normally used, they must be accompanied by a bulky toroidal transformer in order for the DC current be switched by the low voltage transformer into a high frequency AC one. The complimentary PNP/NPN transistors therefore greatly reduce the complexity of the driver circuit, the size of the electronic driver as well as the associated manufacturing cost.

Also referring to FIG. 9, the block circuit diagram of the electronic driver according to the present invention, both the PNP block 121 and the NPN block 122 are supplying electricity to the low voltage transformer 123. Block 121 and block 122 each contains a PNP and a NPN transistor, such as the ST93003 and ST83003, respectively, which are produced by the SGS-Thomson Microelectronics, and both blocks 121 and 122 also have other associated passive components comprising resistor and/or capacitors. With the push-pull switching mechanism provided this pair of PNP/NPN transistors, the low voltage transformer 123 is able to switch the DC current into a high frequency AC one without the use of a bulky toroidal transformer (not shown), thereby reducing the size of the electronic driver substantially.

The above circuitry employing the complimentary PNP/NPN transistors are most useful for the fast start circuitry devised by Embodiment 2 in the above, as the fast start circuitry has two bulky high-voltage transformers. By omitting the bulky toroidal transformer when the complementary PNP/NPN transistor pair is used, the size of the fast-start electronic driver can still be very small for it to fit mostly into the lamp base of the device.

In the embodiment immediately above, and in other embodiments described below, there are many obvious variations for forming said CCFL device. For instance, the electronic driver can be a DA/AC or AC/AC converter, i.e., the input electricity current can be either AC or DC, and the output electricity for the CCFL is high-voltage and high-frequency electricity, with voltage of at least 80 volts and frequency of 10-150 kHz. The lamp base (also known as the electrical connector) can be one of the many conventional lamp bases, which are for mechanical and electrical connection to conventional power outlets. Last but not the least, the light-transmitting container may be any shapes of the conventional incandescent light bulbs, and it can be made of glass or plastic, transparent or translucent (i.e. transmits diffuse light), or may transmit light of only certain color or colors, and it may also comprise in part an inner reflective surface. All these variations are with the scope of the present invention through the various embodiments described herein.

While the invention has been described above by reference to various embodiments, this should not be construed as a limitation on the scope of the present invention. It will be understood that changes and modifications may be made without departing from the scope of the invention, and many other variations and modifications and other uses will become apparent to those skilled in the art. Therefore, the present invention should be limited not by the specific disclosure herein, but rather by the appended claims and their legal equivalents.

1. A cold cathode fluorescent lamp device comprising:
at least one cold cathode fluorescent lamp each with at least one electrode and a hermetically sealed glass envelope;
a lamp base or an electrical connector comprising a shell with a plurality of insulated portions; and
at least one principal amalgam comprising a pre-determined combination of at least one the mercury, lead, bismuth, zinc, indium, tin, silver, gold, platinum, and other metallic elements, wherein said at least one principal amalgam is placed inside said glass envelope at distance of less than 15 millimeters from the nearest surface of said at least one electrode.

2. The device of claim 1, wherein:
said at least one principal amalgam has a surface of a per-determined shape that is connected to a surface of said at least one electrode.

3. The device of claim 1, further comprising:
at least one amalgam connection member that has a first surface connected to a surface of said at least one electrode and has a second surface connected to a surface of said at least one principal amalgam.

4. The device of claim 1, wherein:
said at least one principal amalgam controls the mercury vapor pressure within said glass envelope when said cold cathode fluorescent lamp device is powered on.

5. The device of claim 1, wherein:
each of said plurality of insulated portions of said shell has a contact electrically coupled to said at least one electrode of said at least one lamp.

6. The device of claim 1, further comprising:
an electronic driver that is either an AC/AC or a DC/AC inverter operating said at least one lamp; wherein
each of said plurality of insulated portions of said shell has a contact electrically coupled to said electronic driver, thereby supplying either AC or DC power to said electronic driver.

7. The device of claim 6, further comprising:
an assembly of heat-conductive compound comprising a synthetic material, in which at least one part of said electronic driver is integrally embedded, and said assembly forms at least one surface that is connected to said shell.

8. The device of claim 6, further comprising:
at least one light transmitting container each housing said at least one lamp.

9. The device of claim 6, wherein said electronic driver further comprising:
at least two high-voltage transformers; and
at least one electricity current controlling means being an integral part of the electronic driver;
wherein said controlling means controls the different levels of electricity current supplied to said at least one high-voltage transformer during at least two different times intervals after said cold cathode fluorescent lamp device is powered on.

10. The device of claim 9 wherein
said at least one electricity current controlling means causes the electricity current supplied to said at least on high-voltage transformer to reduce by at least 10% during at least one time interval after said cold cathode fluorescent lamp device is powered on for at least one other time interval.

11. The device of claim 9 wherein said at least one electricity current controlling means further comprises:
a positive temperature coefficient resistor (PTC) that is connected in series with said at least one high-voltage transformer, or
a negative temperature coefficient resistor (NTC) that is connected in parallel with said at least one high-voltage transformer.

12. A cold cathode fluorescent lamp device comprising:
at least one cold cathode fluorescent lamp each with at least one electrode and a hermetically sealed glass envelope; and
an electronic driver that is either an AC/AC or a DC/AC inverter operating said at least one lamp;
a lamp base or an electrical connector comprising a shell with a plurality of insulated portions each has a contact electrically coupled to said electronic driver, thereby supplying either AC or DC power to said electronic driver; wherein
said electronic driver further comprising:
at least two high-voltage transformers; and
at least one electricity current controlling means being an integral part of the electronic driver;
wherein said controlling means controls the different levels of electricity current supplied to said at least one high-voltage transformer during at least two different times intervals after said cold cathode fluorescent lamp device is powered on.

13. The device of claim 12, wherein
said at least one electricity current controlling means causes the electricity current supplied to said at least on high-voltage transformer to reduce by at least 10% during at least one time interval after said cold cathode fluorescent lamp device is powered on for at least one other time interval.

14. The device of claim 13, wherein said at least one electricity current controlling means further comprises:
at least one positive temperature coefficient resistor (PTC) that is connected in series with said at least one high-voltage transformer, or
at least one negative temperature coefficient resistor (NTC) that is connected in parallel with said at least one high-voltage transformer.

15. The device of claim 12, further comprises:
at least one principal amalgam comprising a pre-determined combination of at least one of the mercury, lead, bismuth, zinc, indium, tin, silver, gold, platinum, and other metallic elements,
wherein said at least one principal amalgam is placed within said glass envelope at distance of less than 15 millimeters from the nearest surface of said at least one electrode, and said at least one principal amalgam has a surface of a per-determined shape that is connected to a surface of said at least one electrode.

16. The device of claim 12, further comprises:
at least one principal amalgam comprising a pre-determined combination of at least one of the mercury, lead, bismuth, zinc, indium, tin, silver, gold, platinum, and other metallic elements,
wherein said at least one principal amalgam is placed inside said glass envelope at distance of less than 15 millimeters from the nearest surface of said at least one electrode; and
at least one amalgam connection member that has a first surface connected to a surface of said at least one electrode and has a second surface connected to a surface of said at least one principal amalgam.

17. A cold cathode fluorescent lamp device comprising:
at least one cold cathode fluorescent lamp each with at least one electrode and a hermetically sealed glass envelope; and
an electronic driver that is either an AC/AC or a DC/AC inverter operating said at least one lamp;
a lamp base or an electrical connector comprising a shell with a plurality of insulated portions each has a contact electrically coupled to said electronic driver, thereby supplying either AC or DC power to said electronic driver;
wherein said electronic driver further comprising:
a low voltage transformer electrically connected to a complementary pair of PNP and NPN transistors that switches a low frequency low voltage input DC current of frequency below 1 kHz to a high frequency low voltage output AC current of frequency between 10 kHz to 150 Hz.

18. The device of claim 17, wherein said electronic driver further comprising:
at least two high-voltage transformers; and
at least one electricity current controlling means being an integral part of the electronic driver;
wherein said controlling means controls the different levels of electricity current supplied to said at least one high-voltage transformer during at least two different times intervals after said cold cathode fluorescent lamp device is powered on.

19. The device of claim 18, wherein
said at least one electricity current controlling means causes the electricity current supplied to said at least on high-voltage transformer to reduce by at least 10% during at least one time interval after said cold cathode fluorescent lamp device is powered on for at least one other time interval.

20. The device of claim 19, wherein said at least one electricity current controlling means further comprises:
a positive temperature coefficient resistor (PTC) that is connected in series with said at least one high-voltage transformer, or
a negative coefficient resistor (NTC) that is connected in parallel with said at least one high-voltage transformer.
